(19) United States
(12) Patent Application Publication
(10) Pub. No.: US 2011/0121741 A1
(43) Pub. Date: May 26, 2011

(54) PLANAR ILLUMINATING DEVICE AND DISPLAY DEVICE PROVIDED WITH SAME

(75) Inventors: Manabu Yamamoto, Osaka (JP); Ken Nakazawa, Osaka (JP); Shinya Okuda, Osaka (JP)

(73) Assignee: Sharp Kabushiki Kaisha, Osaka=shi Osaka (JP)

(21) Appl. No.: 12/737,506

(22) PCT Filed: Sep. 30, 2009
(86) PCT No.: PCT/JP2009/067009

§ 371 Date: Jan. 20, 2011

(30) Foreign Application Priority Data
Oct. 1, 2008 (JP) 2008256108

(51) Int. Cl. H05B 37/02

(52) U.S. Cl. 315/193

(57) ABSTRACT

In a backlight device that adjusts brightness by turning on/off switches provided in parallel to respective LEDs, deterioration and breakage of the LEDs, variability in brightness, and flickering are suppressed. In at least one embodiment, a backlight device includes: an LED array including a plurality of LEDs connected in series and bypass switches (transistors) provided in parallel to the respective LEDs; a bypass switch control circuit for switching between an on state and an off state of the bypass switches; an FET having a drain terminal connected to the LED array and a source terminal grounded; a constant current drive control circuit for applying a constant current to the LED array by applying a predetermined voltage to a gate terminal of the FET; and a capacitor whose one end is connected to the gate terminal of the FET and whose other end is grounded.

### TECHNICAL FIELD

The present invention relates to a planar illuminating device used as a backlight or the like of a display device and, more particularly, to a planar illuminating device having a light emitting element array consisting of a plurality of light emitting elements (such as light emitting diodes) connected in series and to which a constant current is applied.

### BACKGROUND ART

In recent years, an LED (Light Emitting Diode) is often employed as a light source for backlight of a display device. In a backlight device, a plurality of LED arrays each consisting of a plurality of LEDs connected in series are disposed in parallel, and a constant current is applied to each of the LED arrays so that the LEDs emit light with constant brightness. By controlling the brightness of the LEDs based on an input image, reduction in the power consumption and improvement in the picture quality are achieved. For example, a screen is divided into a plurality of areas and, based on an input image in an area, the brightness of LEDs corresponding to the area is controlled. With respect to such a backlight device, Japanese Unexamined Patent Publication No. 2005-310996 discloses an invention that transistors are provided in parallel to respective LEDs and the brightness of each LED is adjusted by performing PWM control on the corresponding transistor.

FIG. 10 is a schematic diagram showing the configuration of a main part of a backlight device described in Japanese Unexamined Patent Publication No. 2005-310996. FIG. 10 shows the configuration of only one of a plurality of LED arrays. As shown in FIG. 10, the backlight device includes an LED array 910, an FET (Field Effect Transistor) 922, a constant current drive control circuit 924, and a bypass switch drive circuit 928. The LED array 910 includes a plurality of LEDs 912 connected in series and transistors 914 provided in parallel to the respective LEDs 912. A gate terminal of the FET 922 is connected to the constant current drive control circuit 924, a drain terminal thereof is connected to the LED array 910, and a source terminal thereof is grounded. In such a configuration, a predetermined voltage is applied to the gate terminal of the FET 922 by the constant current drive control circuit 924. Consequently, the FET 922 functions as a constant current element (constant current source) and a constant current flows in the LED array 910. The bypass switch drive circuit 928 switches an on/off state of the transistors 914 provided in parallel to the respective LEDs 912 to perform PWM control on the current flowing in the LEDs. Thus, the transistors 914 function as switches. When the transistor 914 is in the off state, as shown in FIG. 11A, a current flows on the LED 912 side. On the other hand, when the transistor 914 is in the on state, as shown in FIG. 11B, a current flows on the transistor 914 side. Such control of the current is performed on the LED 912 unit basis, thereby adjusting the brightness on the LED 912 unit basis. Note that, as shown in FIGS. 11A and 11B, the flow of a current in each of the LEDs 912 is controlled by turning on/off the transistors 914 provided in parallel to the respective LEDs 912. Consequently, the transistors 914 will be called “bypass switches” below.

### PRIOR ART DOCUMENT

### Patent Document

[Patent Document 1] Japanese Unexamined Patent Publication No. 2005-310996

### SUMMARY OF THE INVENTION

### Problem to be Solved by the Invention

When at least one of the plurality of bypass switches 914 in the LED array 910 changes from the off state to the on state, a large current may temporarily flow in the LED array 910. As a result, the LED deteriorates rapidly. In particularly, when a current exceeding a rated current flows in an LED, the LED may be damaged. Also, a current of magnitude which temporarily varies in each LED array flows, so that the brightness varies among LEDs, and flickering occurs in the eyes of a human.

An object of the present invention is to suppress deterioration and breakage of LEDs, variability in brightness, and flickering in a backlight device which adjusts brightness by turning on/off switches provided in parallel to the respective LEDs.

### Means for Solving the Problems

A first aspect of the present invention is directed to a planar illuminating device comprising:

a light emitting element array consisting of a plurality of light emitting elements which emit light in accordance with magnitude of an applied current and are connected in series;

switches connected in parallel to the plurality of light emitting elements, respectively;

a switch control unit for switching between an on state and an off state of each of the switches connected in parallel to the respective light emitting elements;

a transistor having a control terminal, a first terminal, and a second terminal connected to the light emitting element array;

a constant current drive control unit for making the transistor operate as a constant current source by applying a predetermined voltage to the control terminal; and

a capacitive element provided in parallel to the control terminal—the first terminal.

According to a second aspect of the present invention, in the first aspect of the present invention,

the light emitting element is a light emitting diode.

According to a third aspect of the present invention, in the first aspect of the present invention,

the transistor is a MOS transistor.

A fourth aspect of the present invention is directed to a display device comprising a planar illuminating device according to any one of the first through the third aspects of the present invention.

### Effects of the Invention

According to the first aspect of the present invention, in the planar illuminating device having the light emitting element array consisting of the plurality of light emitting elements connected in series, the switches connected in parallel to the respective light emitting elements, and the transistor functioning as the constant current source for applying a constant current to the light emitting element array, the capacitive element is provided so as to be connected in parallel to a parasitic capacitance which occurs between two terminals other than the terminal (second terminal) connected to the light emitting element array, out of the three terminals of the transistor. Since a constant current is applied to the light emitting element array and the switches are connected in parallel to the respective light emitting elements, when the state of a switch is changed, the potential of the control terminal of the transistor changes. Since the parasitic capacitance occurs between the control terminal and the second terminal of the transistor, when the potential at the second terminal of the transistor rises, the potential of the control terminal also rises. The degree of rise in the potential at the control terminal becomes lower as the capacitance value between the control terminal and the first terminal increases. Here, since the capacitive element is provided between the control terminal and the first terminal, the capacitance value between the control terminal and the first terminal becomes larger than that in the conventional art. Consequently, the degree of rise in the potential at the control terminal in association with the rise in the potential at the second terminal of the transistor becomes lower than that in the conventional art. Therefore, application of a large current to each of the light emitting elements in the planar illuminating device is suppressed, and a peak current is reduced. As a result, deterioration or breakage of the light emitting elements is suppressed. Further, since the differences in the peak current among the light emitting element arrays become smaller than those in the conventional art, variability in the brightness among the light emitting elements are reduced, and flickering given to the eyes of a human is reduced.

According to the second aspect of the present invention, the light emitting diode is employed as the light emitting element. Since a forward voltage drop in the light emitting diode is almost constant, fluctuations in the potential at the second terminal of the transistor are suppressed. Consequently, fluctuations in the potential at the control terminal of the transistor are effectively suppressed.

According to the third aspect of the present invention, since the MOS transistor is employed as the constant current source, the constant current characteristic of the current applied to the light emitting element array is increased. Therefore, fluctuations in the potential at the second terminal of the transistor are suppressed. Consequently, fluctuations in the potential at the control terminal of the transistor are effectively suppressed.

According to the fourth aspect of the present invention, a display device having a planar illuminating device in which deterioration or breakage of the light emitting elements is suppressed and variability in the brightness among the light emitting elements and flickering given to the eyes of a human are reduced is realized.

### BRIEF DESCRIPTION OF THE DRAWINGS

FIG. 1 is a schematic diagram showing the configuration of a main part of an LED backlight device according to an embodiment of the present invention.

FIG. 2 is a block diagram showing a general configuration of a liquid crystal display device having the LED backlight device according to the embodiment.

FIG. 3 is a circuit diagram showing a configuration of a constant current drive control circuit (configuration corresponding to one LED array) in the embodiment.

FIG. 4 is a circuit diagram showing a configuration of a constant current drive control circuit (configuration corresponding to three LED arrays) in the embodiment.

FIG. 5 is a circuit diagram showing a modification of the configuration of the constant current drive control circuit in the embodiment.

FIGS. 6A and 6B are diagrams for explaining the operation performed when a bypass switch changes from an off state to an on state in the embodiment.

FIGS. 7A to 7C are waveform diagrams for explaining the operation performed when the bypass switch changes from the off state to the on state in the embodiment.

FIG. 8 is a diagram for explaining the operation performed when the bypass switch changes from the off state to the on state in the embodiment.

FIG. 9 is a circuit diagram showing a configuration of a constant current drive control circuit in a modification of the embodiment.

FIG. 10 is a schematic diagram showing a configuration of a main part of a conventional backlight device.

FIGS. 11A and 11B are diagrams for explaining a current flowing in an LED array in a conventional example.

FIGS. 12A and 12B are diagrams for explaining operation performed when a bypass switch changes from an off state to an on state in a conventional configuration.

FIGS. 13A to 13C are waveform diagrams for explaining the operation performed when the bypass switch changes from the off state to the on state in the conventional configuration.

FIG. 14 is a diagram for explaining operation performed when the bypass switch changes from the off state to the on state in the conventional configuration.

FIG. 15 is a diagram for explaining operation performed when the bypass switch changes from the off state to the on state in the conventional configuration.

FIGS. 16A and 16B are diagrams for explaining operation performed when the bypass switch changes from the off state to the on state in the conventional configuration.

FIG. 17 is a diagram showing an example of realizing a constant current drive control circuit by using a current mirror circuit in the conventional configuration.

FIG. 18 is a diagram showing an example of realizing a constant current drive control circuit by using an operational amplifier in the conventional configuration.

FIG. 19 is a diagram for explaining the flow of a current in the conventional configuration.

FIG. 20 is a Bode diagram showing frequency characteristics of a constant current control amplifier.

### MODE FOR CARRYING OUT THE INVENTION

### 0. Basic Examination

As described above, according to the conventional art, in a backlight device having an LED array consisting of a plurality of LEDs connected in series and to which a constant current is applied and adjusting brightness of the LEDs by turning on/off switches provided in parallel to the respective LEDs, by making at leapt one of the switches change from an off state to an on state, a large current may temporarily flow in the LED array 910. This will be examined below.

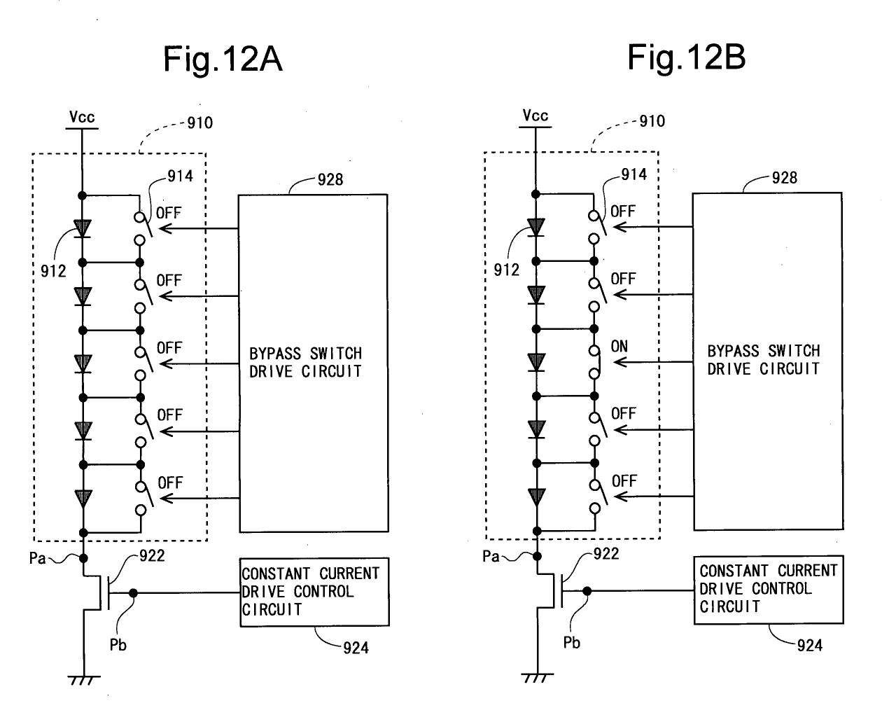

For example, it is assumed that the LED array 910 is configured by five LEDs 912 and five bypass switches 914 and is changed from a state where all of the bypass switches 914 are placed in an off state as shown in FIG. 12A to a state where one bypass switch 914 is placed in an on state as shown in FIG. 12B. When a voltage drop in each of the LEDs 912 when a constant current flows in the LEDs 912 is expressed as VF, a potential (drain potential of the FET 922) Va1 of a node Pa in the state shown in FIG. 12A is expressed by the following equation (1).

Va1=Vcc−5×VF (1)

On the other hand, a potential Va2 at the node Pa in the state shown in FIG. 12B is expressed by the following equation (2).

Va2=Vcc−4×VF (2)

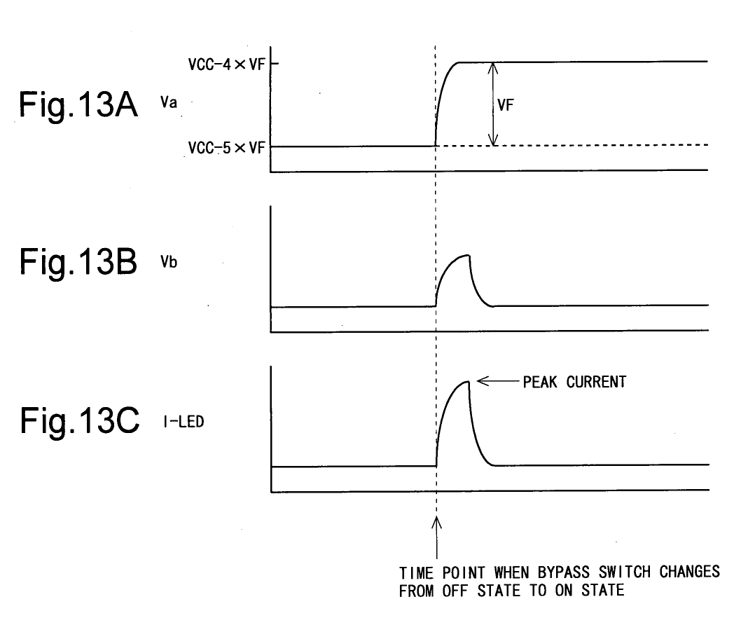

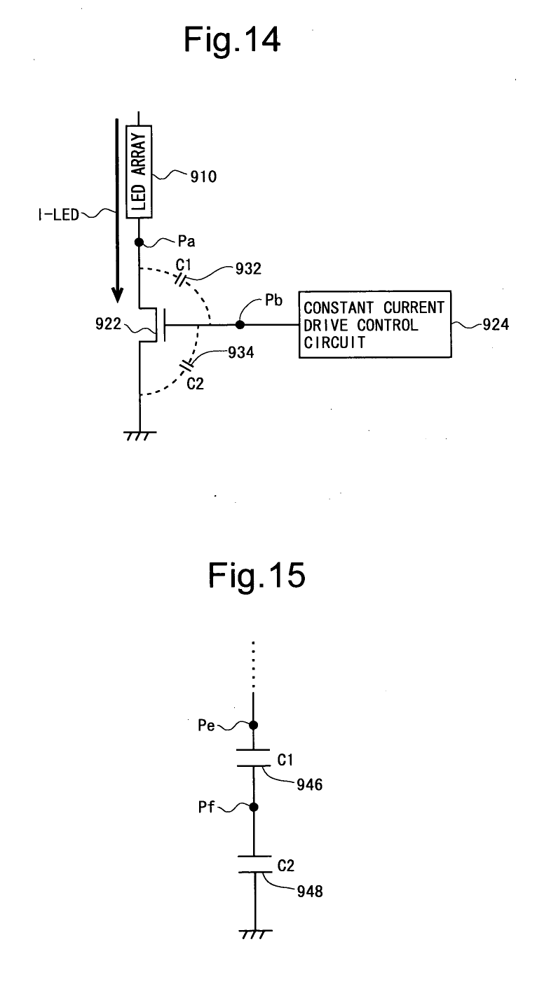

From the equations (1) and (2), when one of the bypass switches 914 is switched from the off state to the on state, the potential Va at the node Pa rises by VF as shown in FIG. 13A. Note that, VF denotes a forward voltage drop (voltage necessary to pass a current in the forward direction) of the LED and is generally 2.5 V to 4 V. By the way, in a configuration employing the FET 922 as a constant current element, as shown in FIG. 14, a parasitic capacitance 932 occurs between the gate and drain of the FET 922 and a parasitic capacitance 934 occurs between the gate and source of the FET 922. Consequently, the potential Va at the node Pa rises sharply as shown in FIG. 13A, a potential (gate potential of the FET 922) Vb at a node Pb temporarily rises as shown in FIG. 13B. Accordingly, the voltage applied to the gate terminal of the FET 922 becomes temporarily large, so that a current I-LED flowing in the LED array 910 temporarily becomes large as shown in FIG. 13C. Note that, because of the characteristics of the FET 922, the larger the potential Vb at the node Pb rises, the larger the current I-LED flowing in the LED array 910 increases.

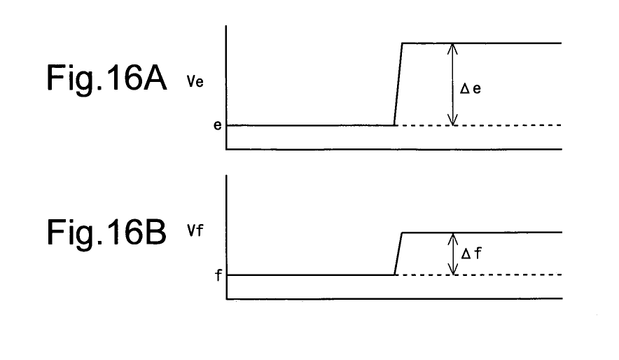

The degree of rise of the potential Vb at the node Pb relative to the rise of the potential Va at the node Pa will be described with reference to FIGS. 15 and 16. It is assumed that, as shown in FIG. 15, the capacitor 946 having a capacitance value C1 and a capacitor 948 having a capacitance value C2 are connected in series, an arbitrary voltage is applied to one end of the capacitor 946, one end of the capacitor 948 is grounded, and the other end of the capacitor 946 and the other end of the capacitor 948 are connected to each other. It is assumed that, when a potential Ve at a node Pe on the side of one end of the capacitor 946 rises from “e” by Δe as shown in FIG. 16A, a potential Vf at a node Pf between the capacitors rises from “f” by Δf as shown in FIG. 16B. When attention is paid to charges accumulated in the capacitors 946 and 948, the following equation (3) is satisfied at a time point before rise of the potential at the node Pe, and the following equation (4) is satisfied at a time point after the rise of the potential at the node Pe.

C1×(e−f)=C2×f (3)

C1×(e+Δe−f−Δf)=C2×(f+Δf) (4)

From the equations (3) and (4), the following equation (5) is satisfied.

Δf=Δe×C1/(C1+C2) (5)

From the equation (5), when attention is paid to FIG. 14, the following is grasped. The larger the capacitance value C1 of the parasitic capacitance 932 between the gate and the drain of the FET 922 is, the larger the degree of the rise in the potential Vb at the node Pb relative to the rise in the potential Va at the node Pa becomes. The larger the capacitance value C2 of the parasitic capacitance 934 between the gate and the source of the FET 922 is, the smaller the degree of the rise in the potential Vb at the node Pb relative to the rise of the potential Va at the node Pa becomes. It is therefore considered to adjust the capacitance values C1 and C2 of the parasitic capacitances 932 and 934. However, the capacitance values of the parasitic capacitances 932 and 934 become values of magnitudes almost parallel to the size of the FET 922 (the gate width of the FET 922). That is, the smaller the size of the FET 922 is, the smaller the capacitance value of the parasitic capacitance is. The larger the size of the FET 922 is, the larger the capacitance value of the parasitic capacitance is. Consequently, it is difficult to increase or decrease only the capacitance value of one of the parasitic capacitances, or to decrease the capacitance value of the parasitic capacitance while increasing the size of the FET 922. Therefore, it is difficult to suppress increase in the above-described current (current flowing in the LED array 910) I-LED by adjusting the capacitance values C1 and C2 of the parasitic capacitances 932 and 934 or the size of the FET 922.

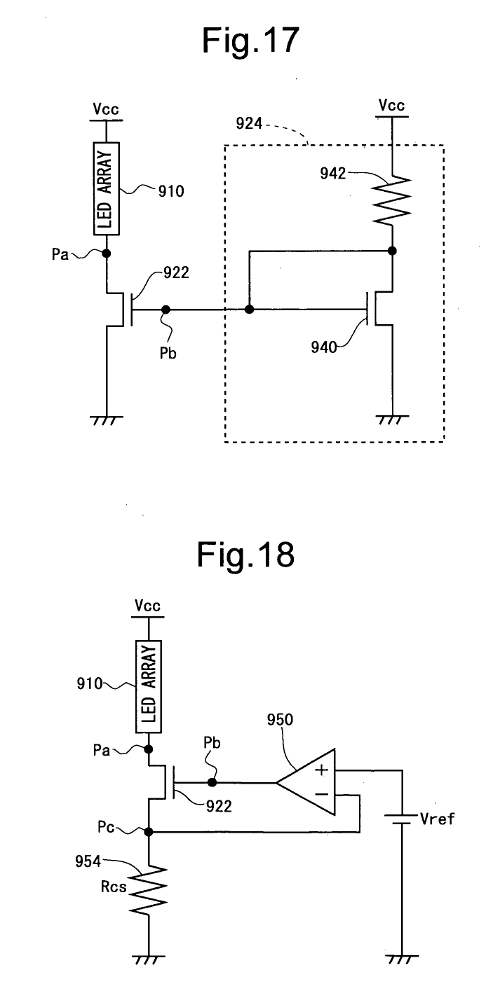

By the way, as typical configurations for applying the constant current to the LED array 910, a configuration as shown in FIG. 17 and a configuration as shown in FIG. 18 are known. These configurations will be described below.

In the configuration shown in FIG. 17, an FET 940 and a resistor 942 are included in the constant current drive control circuit 924. One end of the resistor 942 is connected to a power source Vcc, and the other end is connected to the drain terminal of the FET 940. A gate terminal of the FET 940 is connected to the gate terminal of the FET 922, a drain terminal thereof is connected to the other end of the resistor 942, and a source terminal thereof is grounded. In such a configuration, the gate terminal and the drain terminal of the FET 940 are connected to each other. Therefore, the circuit shown in FIG. 17 functions as a current mirror circuit. The size of the FET 922 is larger than that of the FET 940. With this configuration, a current larger than that flowing between the drain and the source of the FET 940 flows between the drain and the source of the FET 922. For example, when the size of the FET 922 is set to 1,000 times as large as that of the FET 940, a current which is 1,000 times as large as that flowing between the drain and the source of the FET 940 flows between the drain and the source of the FET 922. In such a manner, using the current flowing in the FET 940 as a reference, a current of the magnitude according to the size ratio between the FET 922 and the FET 940 flows in the FET 922. When the current flowing in the FET 940 is constant, the current flowing in the FET 922 is also constant. Since the current flowing in the FET 940 is made constant in the configuration, the FET 922 functions as a constant current element. Note that, since the magnitude of the current flowing in the FET 922 is determined by using the magnitude of the current flowing in the FET 940 as a reference, the FET 940 will be also called an “FET on the reference side” hereinafter. A configuration realizing the constant current drive control circuit 924 using the current mirror circuit as described above will be called a “current mirror type” hereinafter.

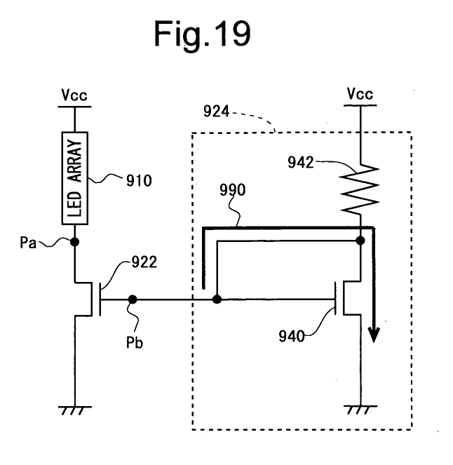

In the current mirror circuit shown in FIG. 17, when the gate potential of the FET 922 (the potential at the node Pb) rises due to the parasitic capacitance between the gate and the drain of the FET 922, a current flows as shown by arrow indicated by reference numeral 990 in FIG. 19 to decrease the charges accumulated in the gate, and a current larger than that in the stationary time flows in the FET 940. Since the current of magnitude according to the size ratio between the FET 922 and the FET 940 flows in the FET 922 as described above, as a result, an extremely large current flows in the FET 922. That is, an extremely large current flows in the LED array 910.

In the configuration shown in FIG. 18, the source terminal of the FET 922 is connected to the other end of a resistor (current sense resistor) 954 whose one end is grounded and also to an inverting input terminal of an operational amplifier 950. A reference voltage Vref is applied to the non-inverting input terminal of the operational amplifier 950. An output voltage from the operational amplifier 950 is applied to the gate terminal of the FET 922. With such a configuration, a negative feedback is given to the operational amplifier 950. Consequently, the operational amplifier 950 operates so that the voltage between the non-inverting input terminal and the inverting input terminal of the operational amplifier 950 becomes zero by an imaginary short-circuit. Therefore, the source potential of the FET 922 (the potential at the node Pc) becomes constant at Vref. Therefore, in the LED array 910, a constant current I expressed by the following equation (6) flows.

I=Vref/Rcs (6)

where Rcs denotes a resistance value of the resistor 954. Note that, in the configuration, the magnitude of the current flowing in the LED array 910 is controlled by the operational amplifier 950, so that a configuration realizing the constant current drive control circuit 924 using such an operational amplifier will be called an “amplifier control type” hereinafter. An operational amplifier for generating a constant current like this operational amplifier 950 will be called a “constant current control amplifier” hereinafter.

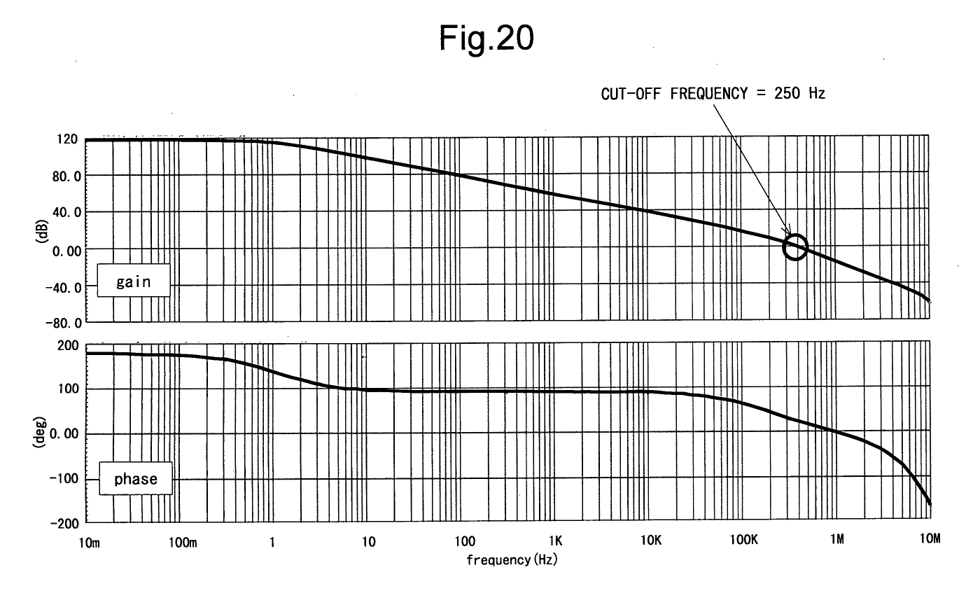

FIG. 20 is a Bode diagram showing frequency characteristics of the constant current control amplifier. As shown in FIG. 20, in the frequency characteristics of the constant current control amplifier, the gain in a high-frequency band is low. Therefore, when the potential at the node Pb rises sharply in association with a change in the state of the bypass switch 914 in the LED array 910, (since the constant current control amplifier cannot handle noise of a high frequency component equal to or higher than the cut-off frequency), the gate potential of the FET 922 is sharply increased. As a result, a large peak current flows in the LED array 910. Note that, when the gain at the phase of 360 degrees (=0.00) is equal to or higher than 0 db, the operation amplifier oscillates. Consequently, the cut-off frequency of the operational amplifier cannot be increased for improving the response when the gate potential is sharply increased.

Based on the above, an embodiment of the present invention will be described with reference to the appended drawings.

### 1. General Configuration and Operation

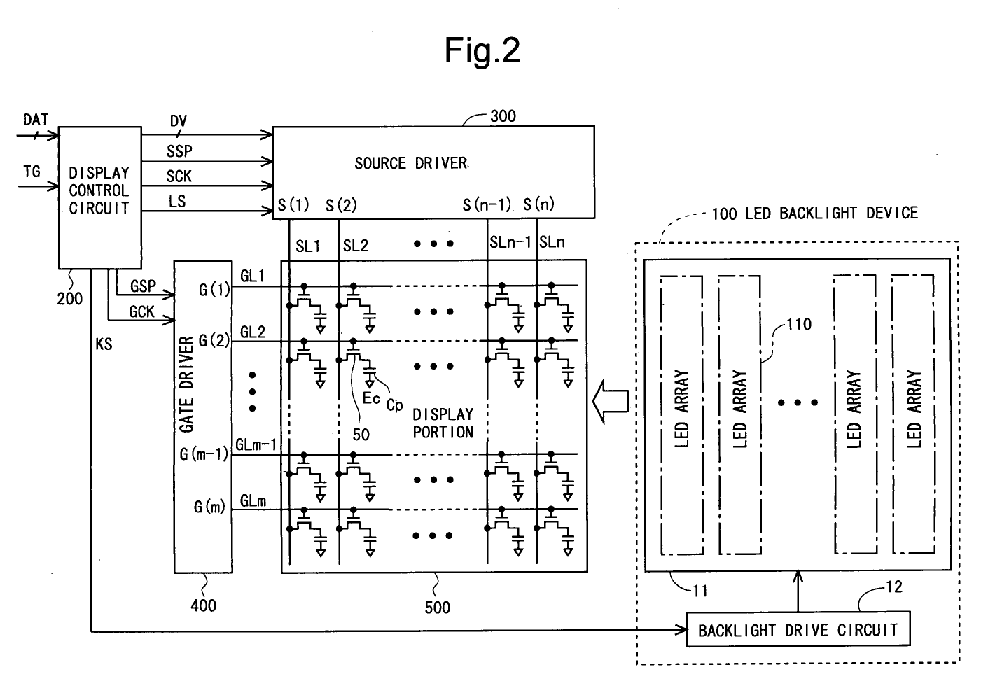

FIG. 2 is a block diagram showing a general configuration of a liquid crystal display device having an LED backlight device according town embodiment of the present invention. The liquid crystal display device has an LED backlight device 100, a display control circuit 200, a source driver (video signal line drive circuit) 300, a gate driver (scanning signal line drive circuit) 400, and a display unit 500. The LED backlight device 100 includes a light emitting unit 11 consisting of a plurality of LED arrays 110 configuring a backlight for emitting light from the rear face of the display unit 500 (to the display unit 500) and a backlight drive circuit 12 for driving the backlight.

The display unit 500 includes a plurality of (n) source bus lines (video signal lines) SL1 to SLn, a plurality of (m) gate bus lines (scanning signal lines) GL1 to GLm, and a plurality of (n×m) pixel formation portions provided at respective intersections of the source bus lines SL1 to SLn and the gate bus lines GL1 to GLm. The pixel formation portions are disposed in a matrix form, thereby configuring a pixel array, and each pixel formation portion has a TFT 50 which is a switching element having a gate terminal connected to a gate bus line passing through a corresponding intersection and having a source terminal connected to a source bus line passing through the intersection; a pixel electrode connected to a drain terminal of the TFT 50; a common electrode Ec which is an opposed electrode commonly provided for the plurality of pixel formation portions; and a liquid crystal layer commonly provided for the plurality of pixel formation portions and sandwiched between the pixel electrode and the common electrode Ec. By a liquid crystal capacitance formed by the pixel electrode and the common electrode Ec, a pixel capacitance Cp is configured. Usually, an auxiliary capacitance is provided in parallel to the liquid crystal capacitance to reliably hold voltage in the pixel capacitance. However, the auxiliary capacitance is not directly related to the present invention, so that it is not described and not shown.

The display control circuit 200 receives an image signal DAT and a timing signal group TG such as a horizontal synchronizing signal, a vertical synchronizing signal, and the like which are sent from an outside, and outputs a digital video signal DV; a source start pulse signal SSP, a source clock signal SCK, a latch strobe signal LS, a gate start pulse signal GSP, and a gate clock signal GCK which are used to control image display in the display unit 500; and a brightness signal KS for controlling the brightness of the backlight. The source driver 300 receives the digital video signal DV, the source start pulse signal SSP, the source clock signal SCK, and the latch strobe signal LS which are outputted from the display control circuit 200 and applies video signals S(1) to S(n) for driving to the source bus lines SL1 to SLn, respectively. The gate driver 400 repeats application of active scanning signals G(1) to G(m) to the gate bus lines GL1 to GLm using a 1 vertical scanning period as a cycle based on the gate start pulse signal GSP and the gate clock signal GCK outputted from the display control circuit 200. The backlight drive circuit 12 receives the brightness signal KS outputted from the display control circuit 200 and drives the backlight. As a result, light is emitted from the rear face of the display unit 500.

In such a manner, the drive video signal is applied to each of the source bus lines SL1 to SLn, the scanning signal is applied to each of the gate bus lines GL1 to Glm, and light is emitted to the rear face of the display unit 500, thereby displaying an image on the display unit 500.

### 2. Configuration and Operation of LED Backlight Device

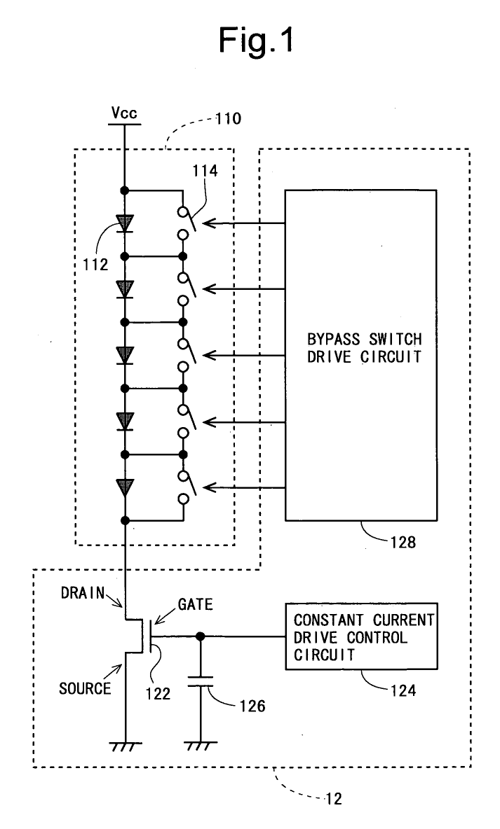

FIG. 1 is a schematic diagram showing the configuration of a main part of the LED backlight device 100 according to the embodiment. As shown in FIG. 1, the LED backlight device 100 includes an LED array 110 as a light emitting element array, an FET 122, a constant current drive control circuit 124 as a constant current drive control unit, a bypass switch drive circuit 128 as a switch control unit, and a capacitor 126 as a capacitive element. The backlight drive circuit 12 is configured by the FET 122, the constant current drive control circuit 124, the bypass switch drive circuit 128, and the capacitor 126. The LED array 110 includes a plurality of LEDs 112 connected in series and bypass switches (transistors) 114 provided in parallel to the respective LEDs 112. A gate terminal (control terminal) of the FET 122 is connected to the constant current drive control circuit 124 and one end of the capacitor 126; a drain terminal (second terminal) thereof is connected to the LED array 110; and a source terminal (first terminal) thereof is grounded. The other end of the capacitor 126 is grounded. Note that, as the FET 122, typically, a MOSFET (Metal-Oxide-Semiconductor Field-Effect Transistor) is employed.

In such a configuration, a predetermined voltage is applied to the gate terminal of the FET 122 by the constant current drive control circuit 124. As a result, the FET 122 functions as a constant current element (constant current source) and a constant current is applied to the LED array 110. The bypass switch drive circuit 128 switches the on/off state of each of the bypass switches 144 provided in parallel to the respective LEDs 112. Thus, the magnitude of the current flowing in each of the LEDs 112 is controlled, and the brightness is adjusted on the LED 112 unit basis.

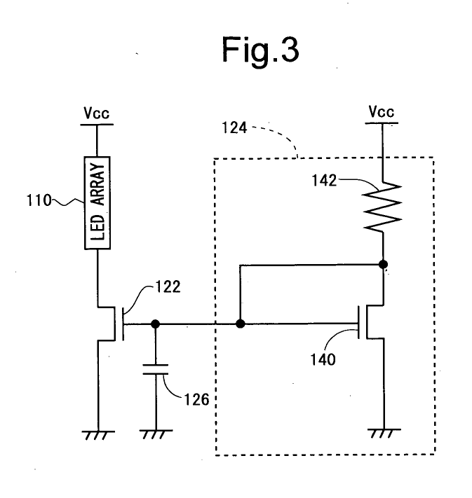

FIG. 3 is a circuit diagram showing a configuration of the constant current drive control circuit 124 in the embodiment. The constant current drive control circuit 124 is of the above-described current mirror type. The constant current drive control circuit 124 includes an FET 140 and a resistor 142. One end of the resistor 142 is connected to the power source Vcc, and the other end is connected to the drain terminal of the FET 140. A gate terminal of the FET 140 is connected to the gate terminal of the FET 122 and one end of the capacitor 126, a drain terminal thereof is connected to the other end of the resistor 142, and a source terminal thereof is grounded. The gate terminal and the drain terminal of the FET 140 are connected to each other. In such a manner, the entire circuit shown in FIG. 3 is configured as a current mirror circuit. Therefore, the constant current is applied to the LED array 110 as described above. The size of the FET 122 functioning as a constant current element is Z times (for example, 1,000 times) as large as that of the FET 140 in the constant current drive control circuit 124. Consequently, a current of the magnitude which is Z times as large as that of a current flowing between the drain and the source of the FET 140 flows in the LED array 110.

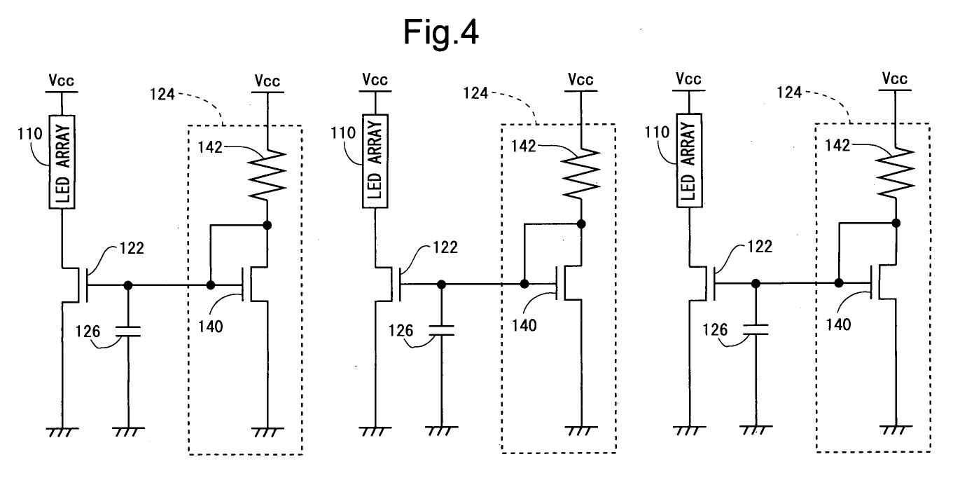

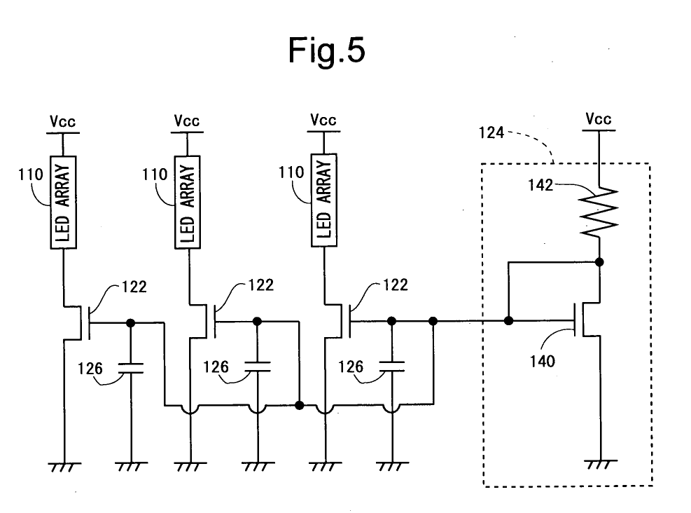

Note that, FIG. 3 shows the configuration of only one of a plurality of LED arrays 110. For example, when the plurality of LED arrays 110 are configured as three LED arrays 110, the constant current drive control circuit 124 is provided for each of the LED arrays 110 as shown in FIG. 4. Although the constant current drive control circuit 124 may be provided commonly to the plurality of LED arrays 110 as shown in FIG. 5, the configuration of FIG. 4 is preferable from the viewpoint of preventing the influence of peak current (which occurs in an LED array 110) when a bypass switch 114 provided in parallel to any of the LEDs 112 in the LED array 110 is changed from the off state to the on state from being exerted on the other LED arrays 110.

### 3. Action and Effect

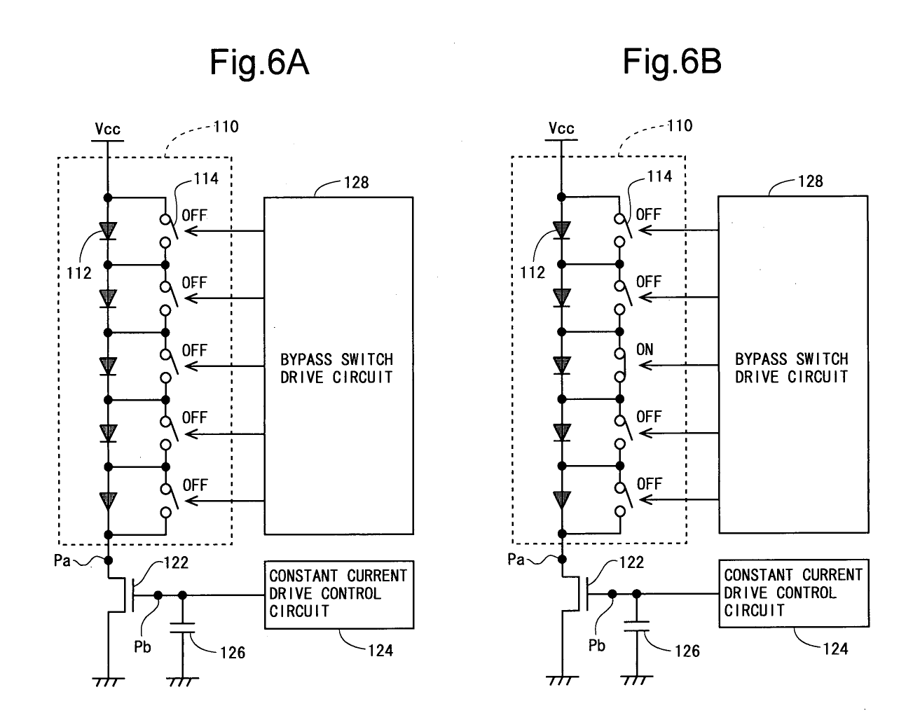

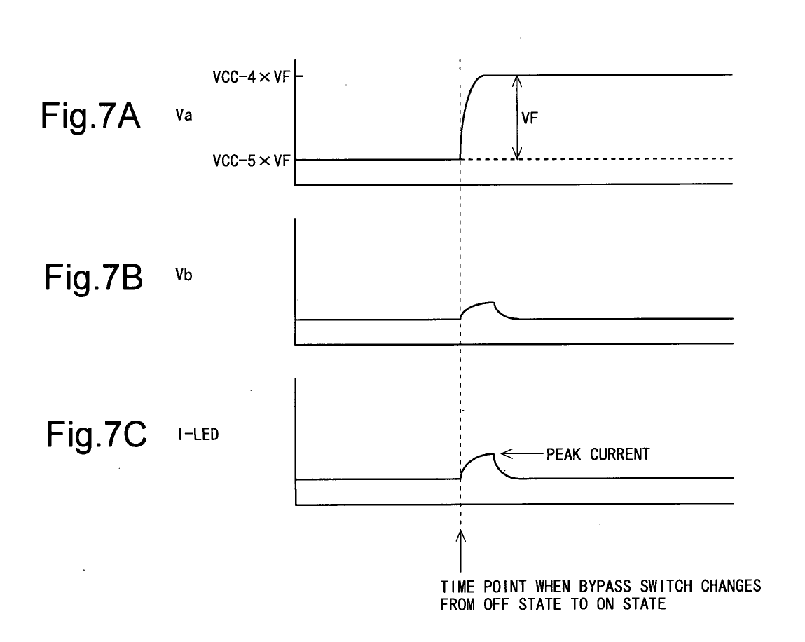

Next, an action when the state of the bypass switch 114 is switched in the embodiment and an effect in comparison to the conventional art will be described. In the description, it is assumed that a state where all of the bypass switches 114 are placed in an off state as shown in FIG. 6A changes to a state where one bypass switch 114 is placed in an on state as shown in FIG. 6B. In the case where a voltage drop in each of the LEDs 112 when a constant current flows in the LEDs 112 is expressed as VF, the potential at a node Pa in the state shown in FIG. 6A is equal to “Vcc−5×VF” from the above-described equation (1), and the potential at a node Pa in the state shown in FIG. 6B is equal to “Vcc−4×VF” from the above-described equation (2). Therefore, as shown in FIG. 7A, in association with a change in the state of the bypass switch 114 (a change from the off state to the on state), the potential Va at the node Pa rises by VF. Note that, in the case where n bypass switches 114 are changed from the off state to the on state, the potential Va at the node Pa rises by “n×VF”. The potential Vb at the node Pb rises with such a rise in the potential Va at the node Pa and, as a result, a peak current flows in the LED array 110. In the embodiment, the peak current is reduced as compared with that in the conventional configuration. This will be described below.

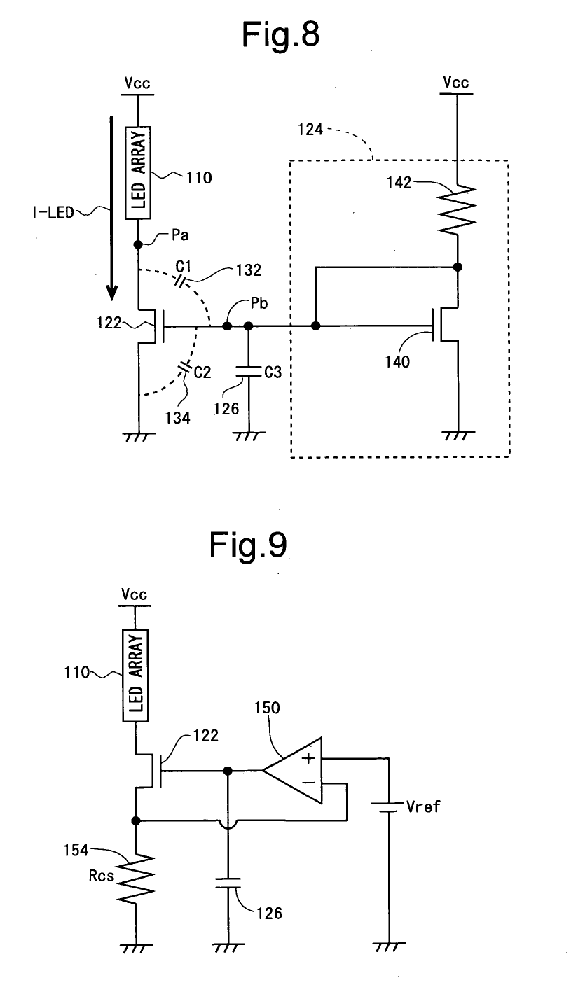

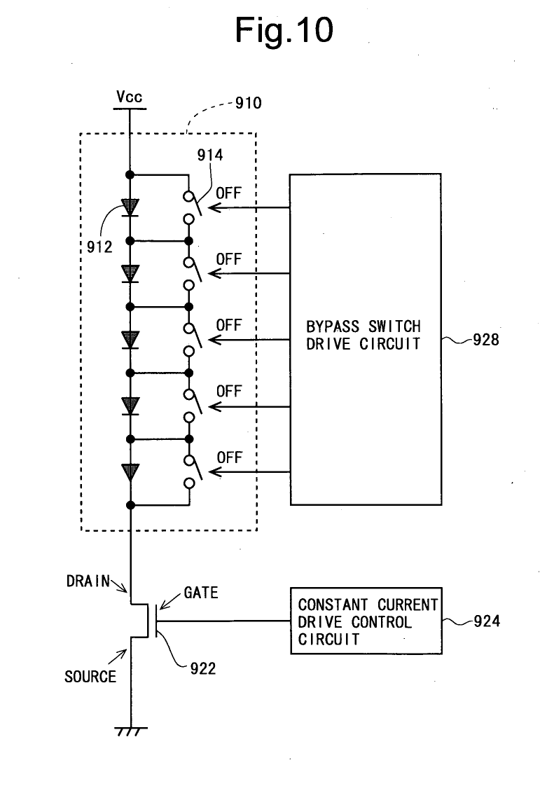

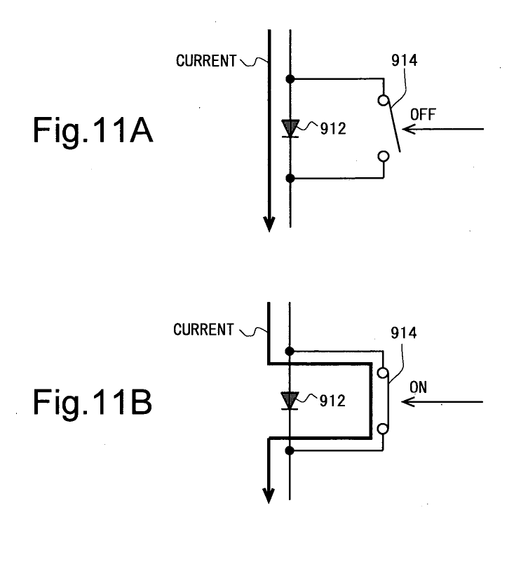

The FET 122 is employed as the constant current element in the embodiment. As shown in FIG. 8, a parasitic capacitance 132 occurs between the gate and the drain of the FET 122, and a parasitic capacitance 134 occurs between the gate and the source of the FET 122. In the embodiment, the capacitor 126 whose one end is connected to the gate terminal of the FET 122 and whose other end is grounded is provided. That is, the capacitor 126 is connected in parallel to the parasitic capacitance 134 between the gate and the source of the FET 122. The capacitance values of the parasitic capacitances 132 and 134 are expressed as C1 and C2, and the capacitance value of the capacitor 126 is expressed as C3. The potential at the node Pa before the state of the bypass switch 114 is switched (that is, “Vcc−5×VF”) is expressed as “e”, the potential at the node Pb before the state of the bypass switch 114 is switched is expressed as “f”, a change in the potential (that is, “VF”) at the node Pa in association with the change in the state of the bypass switch 114 is expressed as “Δe”, and a change in the potential at the node Pb in association with the change in the state of the bypass switch 114 is expressed as “Δf”. When attention is paid to charges accumulated in the parasitic capacitances 132 and 134 and the capacitor 126, the following equation (7) is satisfied at a time point before rise of the potential at the node Pa, and the following equation (8) is satisfied at a time point after the rise of the potential at the node Pa.

C1×(e−f)=(C2+C3)×f (7)

C1×(e+Δe−f−Δf)=(C2+C3)×(f+Δf) (8)

From the equations (7) and (8), the following equation. (9) is satisfied.

Δf=Δe×C1/(C1+C2+C3) (9)

From the equation (9), in the embodiment, it is grasped that the change (rise) in the potential at the node Pb in association with a change in the state of the bypass switch 114 is “Δe−C1/(C1+C2+C3)”. On the other hand, in the conventional configuration, from the equation (5), the change (rise) in the potential at the node Pb in association with a change in the state of the bypass switch 114 is “Δe×C1/(C1+C2)”. Therefore, in the embodiment, the degree of rise in the potential at the node Pb in association with the change in the state of the bypass switch 114 becomes equal to “(C1+C2)/(C1+C2+C3)” in the conventional configuration. That is, according to the capacitance value of the capacitor 126 connected to the gate terminal of the FET 122, the rise in the potential at the node Pb is suppressed more than that in the conventional art. Accordingly, the peak current flowing in the LED array 110 is reduced as compared with the conventional art. For example, the change in the potential Vb at the node Pb as shown in FIG. 13B in the conventional configuration becomes the change shown in FIG. 7B in the embodiment. The change in the current I-LED flowing in the LED array as shown in FIG. 13C in the conventional configuration becomes the change shown in FIG. 7C in the embodiment.

As described above, in the embodiment, in the LED backlight device 100 having the LED array 110 consisting of the plurality of LEDs 112 connected in series, the bypass switches 114 connected in parallel to the respective LEDs 112, and the FET 122 functioning as a constant current element for applying a constant current to the LED array 110, the capacitor 126 whose one end is connected to the gate terminal of the FET 122 and whose other end is grounded is provided. The LEDs 112 are respectively provided with the bypass switches 114. In a state where the brightness of each of the LEDs 112 is adjusted by controlling the on/off state of each of the bypass switches 114, when the state of the bypass switch 114 is changed from the off state to the on state, the potential at the drain terminal of the FET 122 rises. In association with the rise in the potential at the drain terminal, the potential at a gate terminal of the FET 122 temporarily rises. The larger the capacitance value between the gate and the source of the FET 122 is, the degree of the rise in the potential at the gate terminal decreases. In the embodiment, the capacitor 126 is provided in parallel to the parasitic capacitance between the gate and the source of the FET 122, so that the capacitance value as a whole between the gate and the source becomes larger than that in the conventional art. Consequently, the degree of rise in the gate potential in association with the rise in the drain electrode of the FET 122 becomes lower than that in the conventional art. This suppresses flow of a large current in each of the LEDs 112 in the LED backlight device 100, and the peak current is reduced. As a result, deterioration or breakage in the LED 112 is suppressed, and the life of the LED 112 becomes longer. In addition, since the differences in the peak currents among the LED arrays 110 become smaller than that in the conventional art, variability in the brightness among the LEDs 112 is reduced, and flickering given to the eyes of a human is also reduced.

### 4. Modification

In the foregoing embodiment, an example of realizing the constant current drive control circuit 124 by using the current mirror circuit is described. However, the present invention is not limited to the example. As shown in FIG. 9, the constant current drive control circuit 124 may be realized by a circuit using the operational amplifier 150 (amplifier control type as described above). In an example shown in FIG. 9, the FET 122 is employed as the constant current element, and the drain terminal of the FET 122 is connected to the LED array 110. The source terminal of the FET 122 is connected to the other end of a resistor 154 whose one end is grounded and also connected to the inverting input terminal of an operational amplifier 150. The reference voltage Vref is applied to the non-inverting input terminal of the operational amplifier 150, and an output voltage from the operational amplifier 150 is applied to the gate terminal of the FET 122. In a manner similar to the foregoing embodiment, the capacitor 126 whose one end is grounded and whose other end is connected to the gate terminal of the FET 122 is provided.

Also in the modification, by operations similar to those of the foregoing embodiment, the degree of rise in the gate potential of the FET 122 in association with the rise in the drain potential of the FET 122 when the state of the bypass switch 114 in the LED array 110 is changed becomes lower than that in the conventional art. Consequently, flow of a large current in each of the LEDs 112 is suppressed, and the peak current is reduced. As a result, in a manner similar to the foregoing embodiment, deterioration or breakage of the LEDs 112 is suppressed, and the life of the LEDs 112 becomes longer. In addition, variability in brightness among the LEDs 112 is reduced, and flickering given to the eyes of a human is also reduced.

### 5. Others

In the embodiment and the modification, the capacitor 126 is connected to the gate terminal of the FET 122 as a constant current element. However, the capacitor does not pass a direct current, so that the constant current driving itself of “application of a constant current to the LED array 110” is not influenced (by providing the capacitor 126). From the viewpoint of the constant current driving, since the influence of noise is suppressed, a more stable constant current is applied to the LED array 110. Note that, when the current value of constant current is varied (in particular, when a current having a predetermined current value is started to be passed from a state no current flows), time required to reach a target current value becomes longer than that in the conventional art. To shorten the reach time, in the case where the constant current drive control circuit 124 is realized by using the current mirror circuit, it is sufficient to increase the current flowing in the reference-side FET or reduce the size ratio between the FET as the constant current element and the reference-side FET. In the case where the constant current drive control circuit 124 is realized by using the operational amplifier, it is sufficient to increase the current output capability of the operational amplifier.

The example of employing the FET as the constant current element has been described in the embodiment. However, the present invention is not limited to the example. In place of the FET, a bipolar transistor can be employed as the constant current element. In this case, it is sufficient to provide a capacitor so as to be connected in parallel to a parasitic capacitance which occurs between the base and the emitter of the bipolar transistor functioning as the constant current element.

Further, the LED backlight device provided for the liquid crystal display device has been described as an example in the embodiment. However, the present invention is not limited to the example. The present invention can be applied to a backlight device having a light emitting element array consisting of light emitting elements connected in series. Further, the present invention can be applied also to a backlight device provided for a display device other than a liquid crystal display device.

### DESCRIPTION OF THE REFERENCE NUMERALS

11 . . . light emitting unit
12 . . . backlight drive circuit
100 . . . LED backlight device
110 . . . LED array
112 . . . LED (Light Emitting Diode)
114 . . . bypass switch (transistor)
122, 140 . . . FET
124 . . . constant current drive control circuit
126 . . . capacitor
128 . . . bypass switch drive circuit
150 . . . operational amplifier
200 . . . display control circuit
300 . . . source driver (video signal line drive circuit)
400 . . . gate driver (scanning signal line drive circuit)
500 . . . display unit

1. A planar illuminating device comprising:
a light emitting element array consisting of a plurality of light emitting elements which emit light in accordance with magnitude of an applied current and are connected in series;
switches connected in parallel to the plurality of light emitting elements, respectively;
a switch control unit for switching between an on state and an off state of each of the switches connected in parallel to the respective light emitting elements;
a transistor having a control terminal, a first terminal, and a second terminal connected to the light emitting element array;
a constant current drive control unit for making the transistor operate as a constant current source by applying a predetermined voltage to the control terminal; and
a capacitive element provided in parallel to the control terminal—the first terminal.

2. The planar illuminating device according to claim 1, wherein the light emitting element is a light emitting diode.

3. The planar illuminating device according to claim 1, wherein the transistor is a MOS transistor.

4. A display device comprising a planar illuminating device according to claim 1.
